(19) United States
(12) Patent Application Publication
(10) Pub. No.: US 2008/0168648 A1
(43) Pub. Date: Jul. 17, 2008

(54) Manufacturing method and testing method for magnetoresistance effect element

(75) Inventor: Junichi Hashimoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/986,469

(22) Filed: Nov. 21, 2007

(30) Foreign Application Priority Data
Jan. 15, 2007 (JP) 2007-6171

(51) Int. Cl. G11B 5/39; H01R 9/00

(52) U.S. Cl. 29/603.09; 29/603.07; 29/842

(57) ABSTRACT

At the wafer stage of a manufacturing process of magnetoresistive effect elements, the characteristics of the magnetoresistive effect elements can be correctly measured, fluctuations in the characteristics of the magnetoresistive effect elements can be suppressed, and highly reliable magnetoresistive effect elements can be manufactured with a high yield. A method of manufacturing a magnetoresistive effect element includes a process that forms terminals that electrically connect a lower shield layer on both sides of a final position of a air bearing surface and a process that forms terminals that electrically connect an upper shield layer on both sides of a final position of a air bearing surface.

### BACKGROUND OF THE INVENTION

1. Field of the Invention

The present invention relates to a manufacturing method and a testing method for a magnetoresistive effect element, and in more detail to a manufacturing method and a testing method that can correctly measure the resistance of a magnetoresistive effect element during the manufacturing process of the magnetoresistive effect element and thereby make it possible to manufacture highly reliable magnetoresistive effect elements with a high yield.

2. Related Art

A magnetic head installed in a magnetic disk apparatus includes a read head that is composed of a magnetoresistive effect element. In recent years, as the density of magnetic recording has increased, a CPP (Current Perpendicular to Plane)-type magnetoresistive effect element where a sense current is applied perpendicular to a film surface of the read element of the magnetoresistive effect element and an external magnetic field is detected has come into use.

The MR ratio that is one characteristic of a magnetoresistive effect element is expressed as the ratio (ΔR/R) between the resistance R of the magnetoresistive effect element and the rate of change ΔR of such resistance due to the action of an external magnetic field. This means that to correctly measure the MR ratio of the magnetoresistive effect element, it is necessary to correctly measure the resistance R of the magnetoresistive effect element.

FIGS. 8A and 8B show the constructions used when the resistance of the magnetoresistive effect element is measured using a two-terminal method and a four-terminal method, respectively. With the two-terminal method shown in FIG. 8A, aside from the resistance of the element itself, the measured value is influenced by parasitic resistances R1, R2, such as the terminal resistances and contact resistances. Accordingly, the measured value R does not match the resistance R0 of the element. On the other hand, with the four-terminal method shown in FIG. 8B, the influence of the parasitic resistances R1, R2, R3, R4 are eliminated, so that the actual resistance R0 of the element itself can be measured.

Measurement according to the four-terminal method is carried out when measuring a characteristic, such as the MR ratio, of conventional magnetoresistive effect element products (see for example, FIG. 2 of Patent Document 1 and FIG. 4 of Patent Document 2). With the four-terminal method, the MR ratio or the like is measured using a pair of current supplying terminals that are connected to a constant current source and a pair of voltage-measuring terminals.

### Patent Document 1

Japanese Laid-Open Patent Publication No. 2000-188435

### Patent Document 2

Japanese Laid-Open Patent Publication No. 2004-165254

### SUMMARY OF THE INVENTION

However, measuring is not confined to measuring the characteristics of individual magnetic head products. The resistance of a magnetoresistive effect element is measured and the magnetic characteristics are tested also during the manufacturing process of magnetoresistive effect elements. This is carried out because it is necessary during the manufacturing process to test characteristics such as the resistance of the magnetoresistive effect elements and to feed back the test results into the manufacturing process, to exclude defective products discovered during the manufacturing process from subsequent manufacturing processes, and to estimate the intended value of the MR height for a grinding operation carried out during the manufacturing process of a magnetic head.

FIG. 7A is a schematic diagram showing a state where a large number of magnetic heads 6 are fabricated in a row on a wafer 5, and FIG. 7B is an enlargement showing the construction of the magnetic heads 6. As shown in FIG. 7B, a pair of terminals 7a, 7b connected to a magnetoresistive effect element 9 as a read element and a pair of terminals 8a, 8b that are connected to a write head are formed. The line A-A′ shows the position of the air bearing surface when the elements are finally provided as magnetic heads. The magnetic heads are provided by grinding the magnetoresistive effect elements 9 from the air bearing surface side (the direction of the arrow in FIG. 7B) during the manufacturing stage to achieve a predetermined resistance.

With a CPP-type magnetoresistive effect element, the terminals 7a, 7b are respectively connected to a lower shield layer and an upper shield layer to apply a current perpendicularly to the film surface of the element. Conventionally, during the manufacturing process carried out at the wafer stage during the manufacturing of the magnetoresistive effect element, only the pair of terminals 7a, 7b are connected to the element. Accordingly, only the two-terminal method can be used to measure the resistance of the magnetoresistive effect element, which means that conventionally there has been the problem that due to the parasitic resistance of parts aside from the element, it has not been possible to correctly measure the resistance of the magnetoresistive effect element 10.

At the wafer stage, the resistance of the magnetoresistive effect element 10 is low compared to when the final grinding has been carried out and can be similar in magnitude to the parasitic resistance. This means that it is not possible to ignore the influence of the parasitic resistance with measurement methods that use the conventional two-terminal method, which also prevents the resistance from being measured correctly.

Since a CPP-type magnetoresistive effect element such as a TMR element needs high machining precision compared to a conventional magnetoresistive effect element and high-precision control is also required for the deposition conditions, there are demands for more accurate measurement of the resistance of a magnetoresistive effect element.

The present invention was conceived to solve the problems described above, and it is an object of the present invention to provide a manufacturing method and testing method of a magnetoresistive effect element that make it possible to correctly measure the resistance of the magnetoresistive effect element during the manufacturing process of the magnetoresistive effect element and by doing so make it possible to machine magnetoresistive effect elements with high precision, to suppress fluctuations in the characteristics of the magnetoresistive effect elements, and to make it possible to manufacture highly reliable magnetoresistive effect elements with a high yield.

To achieve the object stated above, the present invention is a method of manufacturing a magnetoresistive effect element including: a process that forms a terminal that is electrically connected to a lower shield layer on each of a first side and a second side of a final position of an air bearing surface; and a process that forms a terminal that is electrically connected to an upper shield layer on each of the first side and the second side of the final position of the air bearing surface.

Leads that connect the lower shield layer and the terminals may be patterned during the process that forms the terminals that connect the lower shield layer, and leads that connect the upper shield layer and the terminals may be patterned during the process that forms the terminals that connect the upper shield layer. By forming the leads in a suitable pattern, it is possible to form the terminals at suitable positions.

A method of manufacturing a magnetic head including a magnetoresistive effect element according to the present invention includes, as a process for manufacturing the magnetoresistive effect element: a process that forms a terminal that is electrically connected to a lower shield layer on each of a first side and a second side of a final position of an air bearing surface; and a process that forms a terminal that is electrically connected to an upper shield layer on each of the first side and the second side of the final position of the air bearing surface. The method may further include, after a read head, which includes the magnetoresistive effect element, and a write head have been formed on a wafer substrate: a process that cuts out a row bar from the wafer; and a process that laps the row bar from the second side of the final position of the air bearing surface as far as the final position of the air bearing surface so as to leave the terminals formed on the first side. By lapping the row bar to the final position of the air bearing surface, it is possible to remove the terminals used for measurement from the product and therefore possible to avoid deterioration in the characteristics of a magnetic head product due to the measurement terminals.

A method of testing a magnetoresistive effect element according to the present invention tests the characteristics of the magnetoresistive effect element at a wafer stage, the method including, as a process for manufacturing the magnetoresistive effect element: a process that forms a terminal that is electrically connected to a lower shield layer on each of a first side and a second side of a final position of an air bearing surface; and a process that forms a terminal that is electrically connected to an upper shield layer on each of the first side and the second side of the final position of the air bearing surface, wherein the characteristics of the magnetoresistive effect element are tested using four terminals formed on the first side and the second side of the final position of the air bearing surface.

According to the method of manufacturing and method of testing a magnetoresistive effect element according to the present invention, by providing measurement terminals on the other side of the final position of the air bearing surface when fabricating a magnetoresistive effect element on a wafer substrate, it becomes possible to measure the characteristics of the magnetoresistive effect element using four terminals at the wafer stage. By measuring the characteristics of the magnetoresistive effect element using four terminals, it is possible to eliminate the effects of parasitic resistance and the like and thereby measure the resistance or the like correctly. By doing so, it is possible to suppress fluctuations in the characteristics of a magnetoresistive effect element, which makes it possible to manufacture magnetoresistive effect elements and magnetic heads with a high yield.

### BRIEF DESCRIPTION OF THE DRAWINGS

FIG. 1 is a cross-sectional view where the construction of a magnetoresistive effect element is viewed from the air bearing surface side;

FIG. 2 is a plan view showing the arrangement of leads connected to shield layers;

FIG. 3 is a cross-sectional view taken along the line B1-B1′ in FIG. 2;

FIG. 4 is a cross-sectional view taken along the line B2-B2′ in FIG. 2;

FIG. 5A to FIG. 5F are diagrams useful in explaining manufacturing processes that connect a lower shield layer and leads;

FIG. 6A to FIG. 6E are diagrams useful in explaining manufacturing processes that connect an upper shield layer and leads;

FIGS. 7A and 7B are plan views showing a state where magnetic heads have been fabricated on a wafer; and

FIGS. 8A and 8B are diagrams useful in explaining a two-terminal method and a four-terminal method of measuring resistance.

### DESCRIPTION OF THE PREFERRED EMBODIMENTS

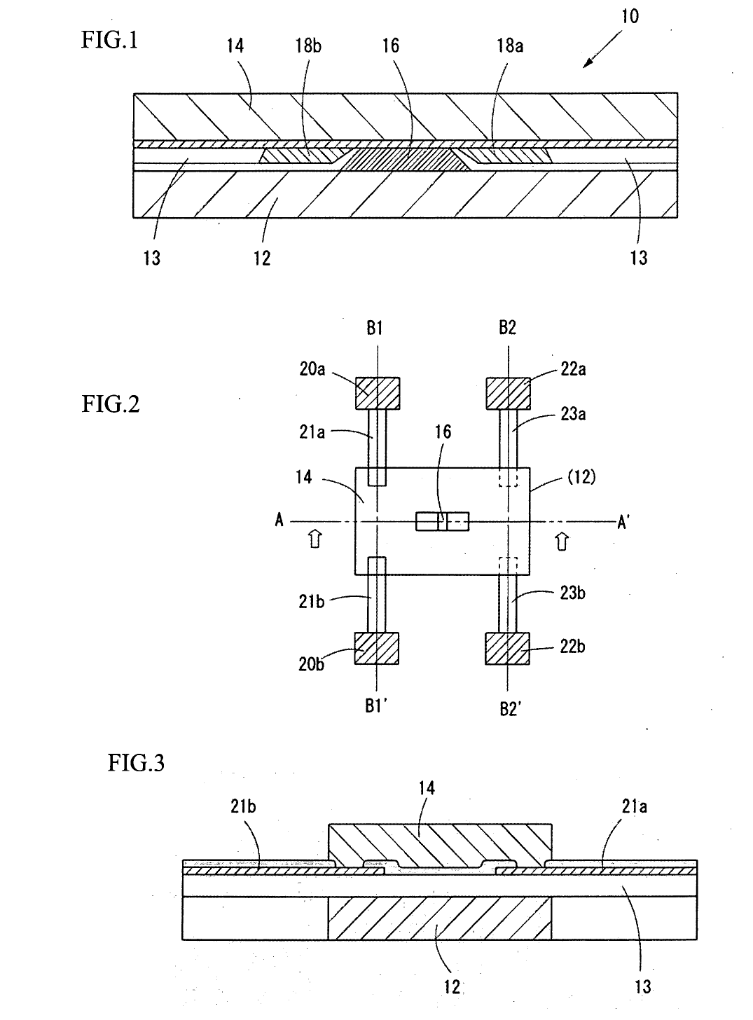

FIG. 1 shows the construction of a TMR (Tunneling Magneto Resistance)-type magnetoresistive effect element 10 when viewed from the air bearing surface side thereof. The magnetoresistive effect element 10 is constructed with a read element 16 sandwiched between a lower shield layer 12 and an upper shield layer 14 in the laminating direction, with hard films 18a, 18b being formed on both sides of the read element 16. The lower shield layer 12 and the upper shield layer 14 are made of a soft magnetic material such as NiFe and the hard films 18a, 18b are made of a magnetic material with high coercivity, such as CoCrPt. The hard films 18a, 18b stabilize the magnetic direction of the free layer formed in the read element 16.

In the TMR element, the lower shield layer 12 and the upper shield layer 14 are connected to external connecting terminals. A sense current is applied perpendicularly to the film surface of the read element 16 so that changes in the resistance of the read element 16 due to the action of an external magnetic field can be detected. For this reason, the side surfaces of the lower shield layer 12 and the read element 16 are insulated between the hard films 18a, 18b by an insulating layer 13.

The read element 16 is constructed by laminating layers such as a pin layer whose magnetization direction is fixed, an antiferromagnetic layer for fixing the magnetization direction of the pin layer, a free layer whose magnetization direction changes according to the action of an external magnetic field, an insulating layer (tunnel layer) provided between the pin layer and free layer, and a protective layer. The hard films 18a, 18b apply a bias magnetic field onto the free layer formed in the read element 16 to stabilize the magnetic domain.

The construction that is characteristic to the manufacturing method for a magnetoresistive effect element according to the present invention is that in addition to the two conventional terminals that are connected to the lower shield layer 12 and the upper shield layer 14 of the magnetoresistive effect element 10, two extra terminals that are connected to the lower shield layer 12 and the upper shield layer 14 for measuring according to the four-terminal method are provided so that the resistance of the magnetoresistive effect element can be measured at the wafer stage according to the four-terminal method.

FIG. 2 shows the planar arrangement of the terminals connected to the lower shield layer 12 and the upper shield layer 14. In the illustrated example, the lower shield layer 12 and the upper shield layer 14 are formed in the same rectangular shapes, and the lower shield layer 12 is formed below the upper shield layer 14 so as to sandwich the read element 16 and the hard films 18a, 18b in the thickness direction.

A first terminal 20a and a second terminal 20b are connected to the upper shield layer 14 at a first side and a second side of the position that will become the air bearing surface when the final grinding process has been carried out (i.e., the line A-A′ position), and a third terminal 22a and a fourth terminal 22b are connected to the lower shield layer 12 on the first side and the second side of the air bearing surface position.

The terminals 20a, 20b and the upper shield layer 14 are electrically connected via leads 21a, 21b and the terminals 22a, 22b and the lower shield layer 12 are electrically connected via leads 23a, 23b. Although the leads 21a, 21b, 23a, and 23b are shown in FIG. 2 as directly extending from the upper shield layer 14 and the lower shield layer 12 for ease of showing the connections between the lower shield layer 12 and the upper shield layer 14 and the terminals 20a, 20b, 22a, 22b, these leads 21a to 23b are formed in a suitable pattern on an actual product.

In FIG. 2, the region on the side (here, “first side”) of the air bearing surface position (i.e., the position of the line A-A′) where the first terminal 20a and the third terminal 22a are formed is the part that will form the final product. The other side (here, “second side”) of the air bearing surface position is a part that is ground away and removed when a row bar is cut out from the wafer and machined into head sliders. Since the row bars are cut out in thin bar shapes from the wafer along the rows in which the magnetic heads have been formed on the wafer, a grinding process is carried out on the row bars which are then diced to produce head sliders. The arrows in FIG. 2 show the grinding direction when machining the row bars. During the actual grinding process, the grinding final position (i.e., MR height) is determined while monitoring the resistance of the magnetoresistive effect element 10 or monitoring the resistance of a lapping guide formed in a separate process.

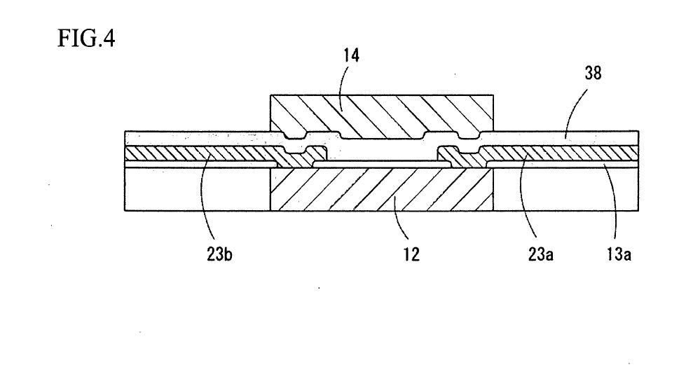

FIGS. 3 and 4 show how the first and second terminals 20a, 20b and the third and fourth terminals 22a, 22b are connected to the upper shield layer 14 and the lower shield layer 12 in cross-section respectively along the lines B1-B1′ and B2-B2′ in FIG. 2.

FIG. 3 shows how the lower shield layer 12 and the upper shield layer 14 are disposed facing one another with the insulating layer 13 in between, how the leads 21a, 21b are formed on the surface of the insulating layer 13, and how the respective ends of the leads 21a, 21b are connected to the upper shield layer 14. FIG. 4 shows how the leads 23a, 23b are connected to the lower shield layer 12 and how the leads 23a, 23b extend from the ends of the lower shield layer 12.

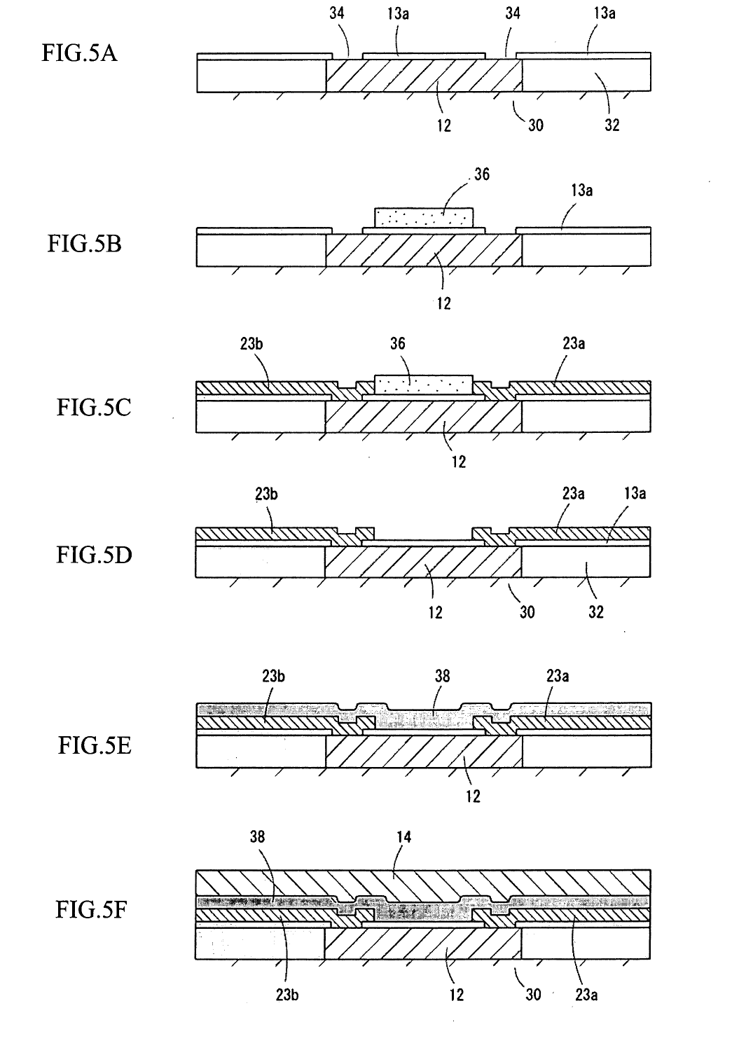

FIGS. 5A to 5F show the process that forms the leads 23a, 23b connected to the lower shield layer 12 during the manufacturing process of the magnetoresistive effect element.

FIG. 5A shows a state after the lower shield layer 12 has been formed in a predetermined pattern on the substrate 30, the work surface has been covered with an insulating material 32 such as alumina, the work has been surface lapped, and the surface of the work has been covered by an insulating layer 13a. In reality, after the work has been surface lapped, a magnetoresistive effect film is laminated on the surface of the work, the laminated magnetoresistive effect film is subjected to ion milling to form the read element 16, and then the surface of the work is covered by the insulating layer 13a.

FIG. 5A shows a state where the surface of the lower shield layer 12 has been covered by the insulating layer 13a and then openings 34 have been formed in the insulating layer 13a by ion milling so as to expose the surface of the lower shield layer 12 at positions where the leads 23a, 23b will be connected.

Next, to form the leads 23a, 23b in a predetermined pattern, the surface of the work is covered by a resist 36 and the resist 36 is patterned. The resist 36 is formed so that the parts where the leads 23a, 23b will be formed are shaped as concave channels.

The leads 23a, 23b are formed by a standard method of forming a conductive pattern. That is, the resist 36 is patterned, a conductive material is deposited by sputtering, and the leads are then formed by lifting off (see FIG. 5C).

FIG. 5D shows a state where the resist 36 has been removed. By simultaneously patterning the third terminal 22a and the fourth terminal 22b when the leads 23a, 23b are formed, it is possible to form the leads 23a, 23b and the third and fourth terminals 22a, 22b.

By doing so, the third terminal 22a and the fourth terminal 22b are formed so as to electrically connect the lower shield layer 12. Since the leads 23a, 23b and the terminals 22a , 22b can be formed in any pattern by forming the resist 36 in a suitable pattern, it is simple to form the leads 23a, 23b and the third terminal 22a and the fourth terminal 22b on both sides of the air bearing surface position as shown in FIG. 2.

Next, the surface of the work including the leads 23a, 23b is covered by an insulating layer 38 (see FIG. 5E) and the upper shield layer 14 is formed (see FIG. 5F). The processes shown in FIGS. 5E and 5F are carried out during the processes that form the leads 21a, 21b under the upper shield layer 14.

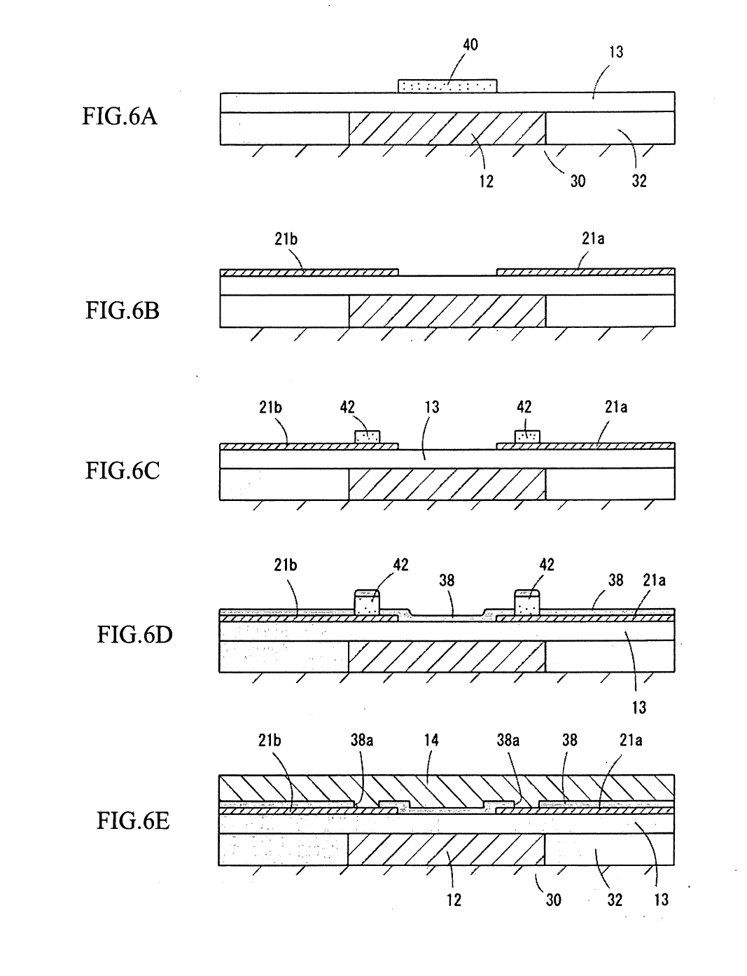

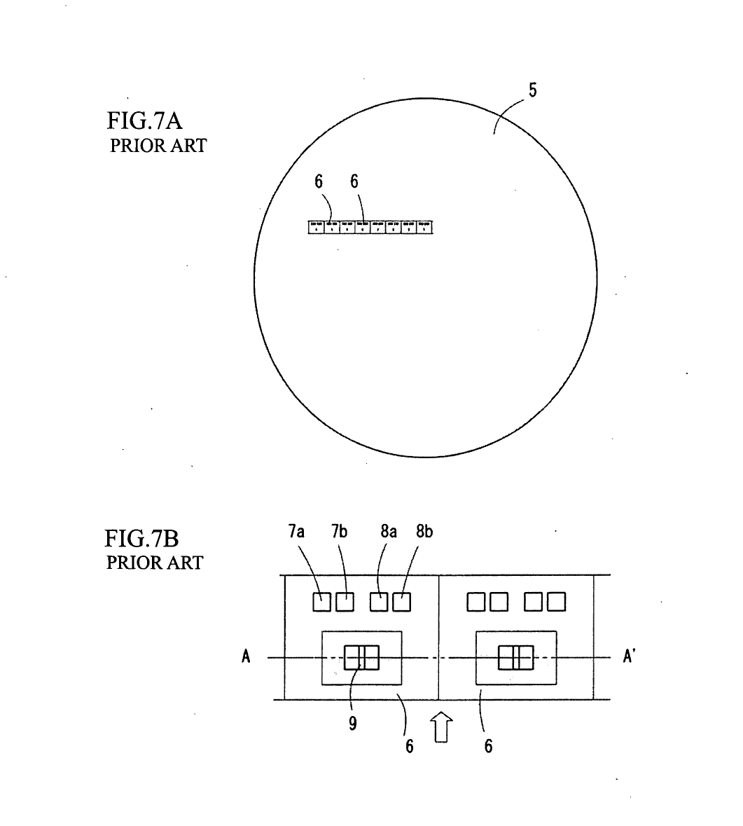

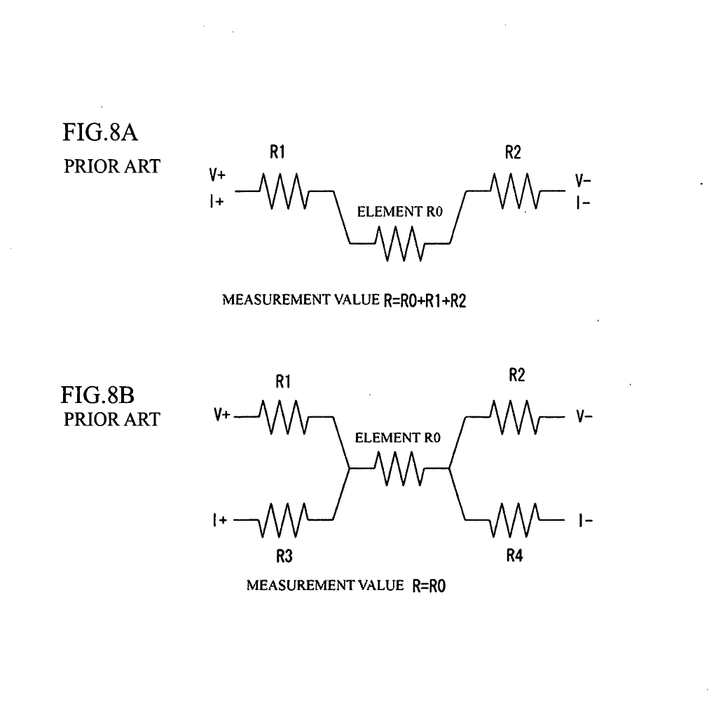

FIGS. 6A to 6E show processes from a state where the leads 23a, 23b have been formed on the surface of the work (i.e., from the state shown in FIG. 5D) until the formation of the leads 21a, 21b to connect the upper shield layer 14.

FIG. 6A shows a state where the surface of the work that has been covered by the insulating layer 13 has been further covered with a resist 40 for patterning the leads 21a, 21b that are connected to the upper shield layer 14 and then the resist 40 has been patterned so that the parts that become the leads 21a, 21b are shaped as concave channels.

FIG. 6B shows a state where the leads 21a, 21b have been formed by depositing a conductive film by sputtering and then carrying out lifting off. When the resist 40 is patterned, by also carrying out patterning for the first and second terminals 20a, 20b, it is possible to simultaneously form the leads 21a, 21b and the first and second terminals 20a, 20b.

Next, after the resist 40 has been removed, the parts of the leads 21a, 21b that will be connected to the upper shield layer 14 are covered with a resist 42 (see FIG. 6C).

In this state, the surface of the work is covered with an insulating layer 38 by sputtering (see FIG. 6D).

The resist 42 is then removed, openings 38a are opened in the insulating layer 38, and the upper shield layer 14 is formed on the insulating layer 38. The upper shield layer 14 can be formed by plating or sputtering. FIG. 6E shows a state where the upper shield layer 14 has been formed. In the illustrated state, the upper shield layer 14 is also formed inside the openings 38a so that the leads 21a, 21b and the upper shield layer 14 are electrically connected.

By patterning the resist 40, it is possible to form the leads 21a, 21b that are connected to the upper shield layer 14 and also the first and second terminals 20a, 20b in freely chosen patterns. It is also possible to form the first terminal 20a and the second terminal 20b to connect to the upper shield layer 14 at positions on opposite sides of the air bearing surface position.

In this way, during the manufacturing process of the magnetoresistive effect element 10, by providing the first and second terminals 20a, 20b that connect the upper shield layer 14 and the third and fourth terminals 22a, 22b that connect the lower shield layer 12, it is possible to measure the resistance of the magnetoresistive effect element 10 using the four-terminal method, to eliminate the parasitic resistance from the magnetoresistive effect element 10, and therefore to correctly measure the resistance of the magnetoresistive effect element 10 itself. To measure a characteristic using the four-terminal method, the first terminal 20a and the third terminal 22a are used to detect voltage and the third terminal 20b and the fourth terminal 22b are used to supply current.

By making it possible to correctly measure the characteristics of the magnetoresistive effect element 10 using the four-terminal method in this way, it is possible to suppress fluctuations in the characteristics of a magnetoresistive effect element, such as a CPP-type magnetoresistive effect element, for which highly precise machining and highly precise control over the deposition conditions are required, which makes it possible to manufacture magnetoresistive effect elements with a high yield.

In particular, with the method according to the present invention, terminals for measuring purposes are formed on the individual elements that are formed on an actual wafer, and the actual resistances of such elements are directly measured individually. Compared to a method where elements for monitoring purposes are incorporated and the characteristics of the actual elements are estimated from the characteristics of the monitor elements, the characteristics can be tested with much higher precision.

Since the terminals that are additionally provided to allow measurement by the four-terminal method (i.e., the second terminal 20b and the fourth terminal 22b in the embodiment described above) are disposed on the side of the air bearing surface position that is removed by lapping during the machining of a head slider, there is the advantage that such measurement terminals do not adversely affect the characteristics of the magnetic head once a head slider product has been produced.

Also, since the measurement terminals are disposed on the opposite side of the air bearing surface position to the product, during the manufacturing process of a magnetoresistive effect element, no restrictions are placed upon conventional manufacturing processes during the patterning of the terminals of the product side of the air bearing surface position or when depositing the read head and write head. There is a further advantage in that the measurement terminals can be provided by merely changing the formation pattern of the terminals during the conventional manufacturing process of a magnetic head.

In addition to the read head that is equipped with a magnetoresistive effect element, a magnetic head also includes a write head. A write coil is formed in the write head and terminals for electrically connecting the coil are also formed. Although the terminals for connecting the coil are formed in a predetermined pattern during the manufacturing process of a magnetic head, the formation positions of the terminals on the write head and the like are not restricted by the method according to the present invention.

Note that according to the method described earlier, the magnetic head is completed by forming the write head after the magnetoresistive effect element 10 that forms the read head has been formed. Next, the row bars are cut out from the wafer on which the magnetic heads have been fabricated and a lapping process is carried out to produce the diced head sliders. These machining processes are carried out according to conventional machining methods.

What is claimed is:

1. A method of manufacturing a magnetoresistive effect element comprising:
a process that forms a terminal that is electrically connected to a lower shield layer on each of a first side and a second side of a final position of an air bearing surface; and
a process that forms a terminal that is electrically connected to an upper shield layer on each of the first side and the second side of the final position of the air bearing surface.

2. A method of manufacturing a magnetoresistive effect element according to claim 1,
wherein leads that connect the lower shield layer and the terminals are patterned during the process that forms the terminals that connect the lower shield layer, and
leads that connect the upper shield layer and the terminals are patterned during the process that forms the terminals that connect the upper shield layer.

3. A method of manufacturing a magnetic head including a magnetoresistive effect element, the method comprising, as a process for manufacturing the magnetoresistive effect element:
a process that forms a terminal that is electrically connected to a lower shield layer on each of a first side and a second side of a final position of an air bearing surface; and
a process that forms a terminal that is electrically connected to an upper shield layer on each of the first side and the second side of the final position of the air bearing surface.

4. A method of manufacturing a magnetic head according to claim 3,
further comprising, after a read head, which includes the magnetoresistive effect element, and a write head have been formed on a wafer substrate:
a process that cuts out a row bar from the wafer; and
a process that laps the row bar from the second side of the final position of the air bearing surface as far as the final position of the air bearing surface so as to leave the terminals formed on the first side.

5. A method of testing a magnetoresistive effect element that tests the characteristics of the magnetoresistive effect element at a wafer stage,
the method comprising, as a process for manufacturing the magnetoresistive effect element:
a process that forms a terminal that is electrically connected to a lower shield layer on each of a first side and a second side of a final position of an air bearing surface; and
a process that forms a terminal that is electrically connected to an upper shield layer on each of the first side and the second side of the final position of the air bearing surface,
wherein the characteristics of the magnetoresistive effect element are tested using four terminals formed on the first side and the second side of the final position of the air bearing surface.
